(19) United States
(12) Patent Application Publication
(10) Pub. No.: US 2020/0073971 A1
(43) Pub. Date: Mar. 5, 2020

(54) METHOD AND SYSTEM FOR ADMINISTERING A NETWORK DATA STRUCTURE

(71) Applicant: Flamingo AI Limited, Perth WA (AU)

(72) Inventor: Jack Winston ELLIOTT, Perth WA (AU)

(21) Appl. No.: 16/119,460

(22) Filed: Aug. 31, 2018

(30) Foreign Application Priority Data
Aug. 30, 2018 (AU) 2018223011

(51) Int. Cl. G06F 17/30; H04L 12/24; H04L 12/26; G06N 99/00

(52) U.S. Cl. CPC G06F 17/30292; G06N 99/005; H04L 43/045; H04L 41/14

(57) ABSTRACT

The present disclosure relates to controlling machine learning algorithms graphically, through a user-friendly interface. Disclosed herein are a method and system of administering a network data structure, wherein the network data structure includes a set of nodes and a set of links between the nodes and further wherein the network data structure specifies a searchable index. The method includes the steps of: generating an initial visual representation of the network data structure based on the set of nodes and the set of links; displaying the initial visual representation in a first region of a user interface; receiving an input from a user via the user interface, the input corresponding to a manipulation of the network data structure; storing the input as an edit in an associated edit history; and rebuilding the network data structure by folding-in edits in the associated edit history to produce a revised network data structure.

### CROSS REFERENCE TO RELATED CASES

The present application is related to and claims priority to Australian Provisional Patent Application No. 2018223011 titled “Method and system for administering a network data structure” and filed in the name of Flamingo AI Limited on 30 Aug. 2018, the entire content of which is incorporated by reference herein.

### FIELD OF THE INVENTION

The present disclosure relates to a method of administering a network data structure where that network represents a machine learning algorithm. In particular, the method generates a visual representation of the network data structure for display in a user interface, wherein the user interface is adapted to receive inputs from a user to view the visual representation and manipulate the represented network data structure.

### BACKGROUND OF THE INVENTION

Machine learning is the discipline of teaching machines from data and training those machines how to respond appropriately to various inputs. A traditional computer program is written in advance, and the rules of execution are forever set. That is, a traditional computer program is written to deal with a specific set of anticipated states and responses and the program, when executed, will operate in a repeatable way.

In contrast, a computer program implemented using a machine learning algorithm responds to new situations based on learned experiences (the algorithm “generalizes” from its learned knowledge) and adapts to new knowledge (incorporating new experience into its execution profile).

As machine learning algorithms are adaptive in character, a common difficulty in operationalising such machine learning algorithms arises relating to how to control a machine that learns behaviour automatically.

Thus, a need exists to provide an improved method and system for controlling operation of a computer program that utilises a machine learning algorithm.

### SUMMARY

The present disclosure relates to a method of administering a network data structure, wherein the network data structure specifies a searchable index, by providing a visual representation of the network data structure and a user interface for receiving user inputs to manipulate the network data structure.

A first aspect of the present disclosure provides a method of administering a network data structure, wherein the network data structure includes a set of nodes and a set of links between the nodes and further wherein the network data structure specifies a searchable index created by a machine learning algorithm, the method comprising the steps of:
generating an initial visual representation of the network data structure based on the set of nodes and the set of links;
displaying the initial visual representation in a first region of a user interface;
receiving an input from a user via the user interface, the input corresponding to a manipulation of the network data structure;
storing the input as an edit in an associated edit history;
rebuilding the network data structure by folding-in edits in the associated edit history to produce a revised network data structure.

A second aspect of the present disclosure provides a system for administering a network data structure, wherein the network data structure includes a set of nodes and a set of links between the nodes and further wherein the network data structure specifies a searchable index, the system comprising:
a graph manager that receives the network data structure and generates an initial visual representation of the network data structure based on the set of nodes and the set of links;
a software client adapted to display the initial visual representation in a first region of a user interface on a display of a client computing device, wherein the user interface is adapted to receive an input from a user via the user interface, the input corresponding to a manipulation of the network data structure;
a persistent store for storing the user input as an edit in an associated edit history;
a graph builder for rebuilding the network data structure by folding-in edits in the associated edit history to produce a revised network data structure.

According to another aspect, the present disclosure provides an apparatus for implementing any one of the aforementioned methods.

According to another aspect, the present disclosure provides a computer program product including a computer readable medium having recorded thereon a computer program for implementing any one of the methods described above.

Other aspects of the present disclosure are also provided.

### BRIEF DESCRIPTION OF THE DRAWINGS

One or more embodiments of the present disclosure will now be described by way of specific example(s) with reference to the accompanying drawings, in which:

FIG. 1 is a high-level flow diagram illustrating creation and manipulation of a graph;

FIG. 2 is a schematic block diagram representation of logical components of a system for administering a network data structure;

FIG. 3 is a schematic block diagram representation of a system for administering a network data structure;

FIG. 4 is a schematic block diagram representation of a system that includes a general-purpose computer on which one or more embodiments of the present disclosure may be practised;

FIG. 5 is a schematic block diagram representation of a graphical user interface relating to a system for administering a network data structure;

FIG. 6 is a visual representation of a macroscopic graph of a network data structure;

FIG. 7 is a visual representation of the macroscopic graph of FIG. 6, showing colouring of some arbitrary attribute;

FIG. 8 is a visual representation of a microscopic solar system, arranging nodes of a network data structure in space;

FIG. 9 is an extreme closeup view of a single node and its neighbourhood;

FIG. 10 is a graphical user interface for administering a network data structure; and

FIG. 11 is a detailed view of a graph neighbourhood with colouring after adding an attribute to some nodes of that graph.

Method steps or features in the accompanying drawings that have the same reference numerals are to be considered to have the same function(s) or operation(s), unless the contrary intention is expressed or implied.

### DETAILED DESCRIPTION

The present disclosure provides a suite of back-end tools that make it possible not only to deploy machine learning algorithms, but also to control such algorithms. In particular, the present disclosure provides a two-pronged approach: (i) an administrative interface that allows the direct manipulation of machine learning “knowledge” on which the behaviour is ultimately based; and (ii) a visualisation that allows users to understand directly the runtime behaviour of a computer program utilising machine learning algorithm.

Embodiments of the present disclosure enable users with no background in machine learning to instrument the algorithms and data that they have trained in advance. In particular, embodiments provide a user interface for receiving user input to allow the manual insertion and/or retraction of automatically learned knowledge, and the visualisation of the decision “space”.

A common form of knowledge encapsulation is a “graph”, which is essentially a network that stores links between objects. A graph may be considered to be a network data structure that includes a set of nodes and a set of links between the nodes. The present disclosure relates to network data structures that specify searchable indices relating to various objects. Depending on the application, the objects can be anything, such as documents for a retrieval system, stock-market shifts in a trading platform, or individuals in a medical experiment. The links between the objects (i.e., nodes) are learned as part of the machine learning algorithm. Network data structures can be used for all sorts of methods, including, for example, but not limited to, gaussian processes, kernel methods, or implicit in neural network models.

Combining network visualization, network manipulation, and answer editing provides a user with almost complete control over any machine learning algorithm that can be serialized as a network. The network learning phase takes raw data and learns a structure (i.e., a network), placing objects close together or far apart depending on some notion of similarity. Network manipulation takes this structure and allows administrative users to make edits, moving objects around this network based on what a user feels should be close together or far apart.

Building a network is done during a training or learning phase of an algorithm. To make decisions based on this learned model, a new data point is projected into the network and compared to a set of existing objects in the network. This comparison then informs the decision that the machine ultimately makes. In the case of document retrieval, documents “like” the search term are retrieved. For patient classification, diagnosis is aided by returning cases similar to a new patient that is to be classified.

The present disclosure relates to a graphical user interface suitable for use with a question-answering machine that matches unseen questions with previously seen answers. This is done by building a (potentially very large) network of previously seen questions, some of which are paired with answers. New unseen questions are then projected into this network, and distances between the projected unseen question and the previously seen questions are measured. The closest already-observed question with an answer is the winner—its linked answer is returned by the algorithm.

The trade-off for the flexibility offered by machine learning is a concomitant loss of control. Control is delegated to a machine, so that efficiencies can be realised and scale achieved, but the machine operates semi-autonomously based on the data that it has learned. The present disclosure instruments and visualizes the network that the machine uses to inform its decisions—allowing an administrative user to “think” like the algorithm and thus offering tighter control over the decision-making process of the machine. By allowing users to visualise and manipulate the graph that the machine will use at runtime, tighter control can be exercised around the runtime behaviour of the machine.

Furthermore, answers linked to questions in the network can be modified at the discretion of an administrative user. So not only can the network lookup be visualized and controlled by our administrative users, but the resulting answer-text or response-behaviour of the system can also be changed.

When observing the output of the learning process as a network, we can not only predict the lookup behaviour of the network, but also better understand the learning process itself. If a network is freely navigable, with most objects within a few hops of each other (a small world), our learning process is working on a dense, tightly-connected space. If the network is only weakly connected, then the learning process is taking place over a sparse, thinly-sampled space.

Embodiments of the present disclosure presuppose two other components: (i) a machine learning layer that learns a network structure (i.e., creates a graph based on input data); and (ii) a machine that consumes that network and performs searches during runtime to retrieve appropriate answers. Embodiments of the present disclosure enable a user to change the behaviour of the network searcher by altering the structure or data present in the network after that network has completed an initial learning phase.

As mentioned above, a first component creates a graph based on input data, wherein the input data comprises natural language text. This first component may be referred to as a graph-emitting machine learner. Creating the graph includes the steps of transforming the input data into transformed text strings and then comparing the transformed text strings to determine distances between the transformed text strings. The method structures the transformed text strings and distances into a searchable graph, wherein each text string has a corresponding node in the graph. The method matches nodes in the graph corresponding to seen questions with their corresponding seen answers and allocates, for each seen question, a standardised answer weight to the node in the graph that corresponds to that seen question. The method then distributes the nodes throughout the graph. Different embodiments may apply weightings to the nodes to distribute the nodes throughout the graph.

As noted above, the input data on which the graph is based comprises natural language text that includes seen questions, background text, and seen answers. Further, distributing the nodes throughout the graph includes propagating answer weights throughout the graph, such that for each seen question, the node in the graph corresponding to that seen question has a standardised answer weight for that seen question and neighbouring nodes in the graph have corresponding adjusted answer weights based on their respective distances from the node in the graph corresponding to the seen question. The neighbouring nodes are not restricted to nodes that relate to seen questions, rather the neighbouring nodes may relate to both seen questions and background text.

In one arrangement, distributing the transformed text strings throughout the graph is performed using an hierarchical navigable small-world index. This index is then enriched by a Kriging engine. The input data may include a set of questions, file contents, or a combination thereof. The graph may be embodied in different ways, such as one or more columns or a matrix. In one implementation, the graph is a matrix weighted using a TF-IDF transform. In one implementation, string kernels are used as the distance measure.

Querying the graph in response to a new question occurs during runtime, with the new question received as an input from a user. The new question may be a seen question or an unseen question. The user may be, for example, a caller speaking on a telephone to an interactive voice response (IVR) system, or a user accessing a computing device to provide a question to a user interface of a website or software application (“app”) operated by a company, such as a chatbot. Querying the graph includes the step of projecting the question into the graph to a projected location. Depending on the implementation, the method generates a question node at the projected location. If the projected question finds at least one matching node close-by in the graph (i.e., within a retrieval radius associated with the projected question) and there is an answer associated with one of the matching nodes, then the method selects a best answer from the answers associated with the matching nodes, as described below. Otherwise, the question is escalated. Depending on the scenario, escalating the question may include diverting the question to a human operator or asking the user associated with the question to rephrase the question, in anticipation that the same question rephrased using different words may match a node in the graph.

Identifying matching nodes within the retrieval radius associated with a new question includes determining a set of answer weights based on the distances between the projected location and retrieved nodes and answer weights associated with retrieved nodes based on seen questions. The method determines a best response corresponding to the seen answer associated with the highest answer weight from the set of answer weights determined for each retrieved node within the retrieval radius.

The created graph includes links between objects that represent distances between those objects. In one embodiment, the graph is created for use in a chatbot and the objects in the graph are input data relating to seen questions, background text and seen answers. In one particular embodiment, the input data relates to hundreds of thousands of chat messages. However, different applications will utilise different input data and the objects can be any objects that can be compared to each other.

By providing summary statistics (such as weighted degree) on the graph, certain behaviours can be observed: are the links between objects primarily describing “close” relationships, or “distant” ones? If the space is composed primarily of objects close to each other, it can be said that the learning process is sampling a densely connected space. This means that fewer data points are needed to converge to a well-sampled solution, but algorithms might have problems differentiating between possible courses of action. Conversely, if a graph is composed primarily of objects weakly connected to each other, then more sampling is definitely required but choices between different courses of action are much more likely to be distinct.

Embodiments of the present disclosure take the learned network and allow a user to make a series of edits to the learned network before feeding the network through to the network searcher to process received questions during runtime. Parts of the network that appear to be under-sampled can be cut and discreet parts with some commonality can be joined together. The links between nodes can also be selectively reweighted: emphasizing the link where a user determines two nodes are more alike than the algorithm believes, but penalizing the link in cases where a user believes two nodes are more dissimilar than the algorithm suggests.

In particular, embodiments of the present disclosure provide a graphical user interface that includes a visual representation of the network data structure corresponding to the graph created from the input data. The visual representation directly exposes the network metaphor behind the machine learning algorithm. Direct visualisation of this layer of the machine learning enables users to better understand how different types of objects hang together. In the case of a network data structure created from input data that includes a set of documents, a user can view a visual representation of the network data structure and easily see that documents that they might intuitively consider alike have been placed in different parts of the network—or that chat messages the user considers very dissimilar are actually placed close together by the graph-emitting machine learner.

The links between questions and answers are also maintained through the graphical user interface. The graphical user interface provides administrative tools that enable administrative users to manipulate the network data structure, such as adding nodes, deleting nodes, and altering the answers returned by individual lookups. The administrative tools may also include tools to change viewing parameters of the network data structure, such as zooming in, zooming out, translating the network data structure up, down, left, or right. The tools may optionally enable a user to select objects of particular interest, such as objects within a particular retrieval radius of a user-selected node. In this way, a user can identify all nodes within a certain distance of the user-selected node. Various colours and/or colour densities may be used to highlight different portions of the network data structure, such as particularly dense or sparse portions of the network data structure.

Once a visual representation of a network data has been constructed for a network data structure, the question arises as to how to ensure the manipulations of an end user be persisted, despite the machine continuing to learn. If the network represents the learning of a machine, then how can a user make meaningful manipulations to this environment? Once any new knowledge has been incorporated into this machine, the manipulations will be lost, too. In order to address this technical problem, the method and system of the present disclosure save the results of the manipulations as a series of edits that are stored in a separate store to the main network. This store, which may be referred to herein as an associated edit history, can be interrogated and the edits can be retrieved and reapplied when the network is rebuilt. When the network is to be re-built in order to learn from new input data, the edits in the associated edit history are folded-in with the new input data to produce a revised network data structure.

Let us consider an example. A user receives a network that a machine has learned. The user uses a graphical user interface to a make a manipulation to the network, deleting a few links on the graph and creating an artificial “divide” on the graph. This means that queries on the network at one point are not similar to points on the other side of these deleted links. At runtime, the queries are appropriately distorted, and queries on one side of this divide do not retrieve nodes on the other. The machine then relearns the graph, rebuilding all the links in the original, first, network that the user manipulated. This new network would not have the artificial divide induced by our user; rather, the relearnt graph has all links present and correct.

Utilising an associated edit history saves all manipulations as a network editing language, stored in a separate location to the learned graphs. Manipulations are then “replayed” after newly-learned networks are built by the network learner.

The network manipulation language that enables manipulation of the network does not simply allow deletion of links between nodes: users may add new links or nodes if they wish, or introduce other distortions into the network “space”. Each of these manipulations is saved to a persistent store (i.e., the edit history), and later retrieved and replayed each time the network structure is relearned.

Users may also visualize all their previously saved manipulations and delete those manipulations that are no longer necessary, or that have inhibited proper functioning of the graph.

In addition to manipulating the structure of the graph, the graphical user interface enables users to change the response retrieved from the network when queried at runtime. In a typical case, a response will be the answer to a question, but it could be a request for more information from a consumer, instructions to an external API or any other function executable on a machine. These responses are themselves editable (where a response is not general-purpose enough or otherwise inadequate) or deletable (when a response should not have been learned in the first place).

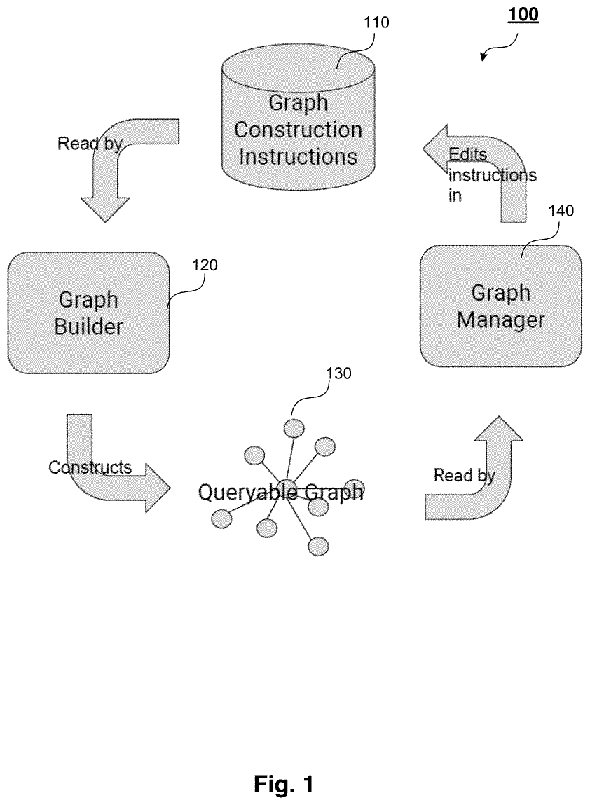

FIG. 1 is a high-level flow diagram 100 illustrating creation and manipulation of a graph. Graph creation instructions 110 are presented to a graph builder 120. In an initial phase of graph creation, the graph creation instructions 110 may relate solely to input data. For example, in relation to a machine learning application to create a graph for consumption by a chatbot, the input data may be natural language text that includes one or more of seen questions, background text, and seen answers.

The graph builder 120 constructs a network data structure 130 that specifies a searchable index created by a machine learning algorithm. Such a network data structure may be referred to as a queryable graph. The queryable graph 130 is read by a graph manager 140. The graph manager provides an interface for a user to administer the queryable graph 130, wherein the interface provides a visual representation of the queryable graph 130. For example, the user may view the queryable graph 130, zooming in to interrogate particular nodes and/or links.

Depending on the application, the graph manager 140 may provide a set of controls that enable the user to manipulate the queryable graph 130. The controls may include a text box for receiving command line instructions, one or more graphical controls, or a combination thereof. Graphical controls may include, for example, scroll arrows, and icons associated with a set of predefined commands, such as, but not limited to, adding a node, deleting a node, adding a link, deleting a link, dividing the graph, cutting a portion of the graph, redistributing nodes within the graph, and the like. Any edits made by the user via the graph manager 140 are fed back to the graph construction instructions 110, to be stored in persistent storage as a set of edits in an edit history associated with the queryable graph 130. The graph builder 120 reads the graph construction instructions 110 whenever it is re-building the graph and in doing so folds-in the edits from the edit history to ensure that all manipulations made to the queryable graph 130 are preserved in subsequent constructions of the queryable graph 130.

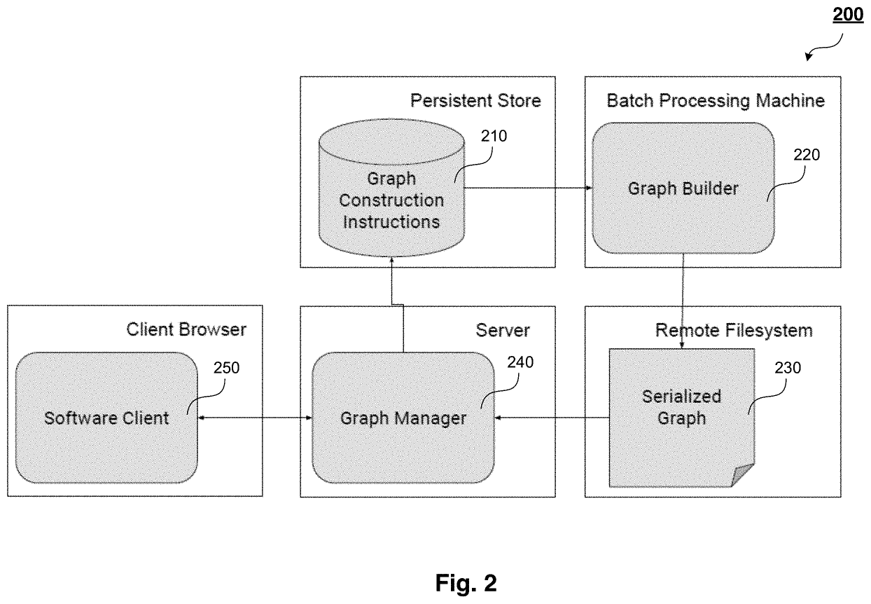

FIG. 2 is a schematic block diagram representation of logical components of a system 200 for administering a network data structure. The system 200 includes a persistent store 210 that stores graph construction instructions, which include input data and an edit history. The edit history stores all edits made in relation to the network data structure. The graph construction instructions are presented by the persistent store 210 to a graph builder 220. The graph builder 220 constructs a network data structure that includes a set of nodes and a set of links between the nodes, wherein the network data structure specifies a searchable index created by a machine learning algorithm.

The network data structure constructed by the graph builder 220 is stored in a remote filesystem as a serialized graph 230. The serialized graph 230 is presented to a graph manager 240. The graph manager 240 executes on a server and allows runtime execution to query the graph 230. In the example of FIG. 2, the graph manager 240 communicates with a software client 250 executing on a client computing device to enable a user to administer the graph 230. In one implementation, the software client is a software application executing on the client computing device. In an alternative implementation, the software client 250 is implemented as a web browser based application executing on the server hosting the graph manager 240, with the server pushing information for display on the client computing device and receiving user input via a graphical user interface presented within a browser window.

The graph manager 240 generates a visual representation of the graph 230 for viewing on a display of the client computing device. The user is able to manipulate the graph 230 via a user interface associated with the software client 250. Any user input provided by the user is presented to the graph manager 240 and user inputs relating to manipulation of the graph 230 are stored as edits in the edit history of the graph construction instructions stored in the persistent store 210.

The three mechanisms described herein—network visualization, network manipulation and response manipulation—work together to give complete control to administrative users. A user starts their session by noticing that a part of the network is not as they expect, by examining a visual representation of the network. The user is then able to “clean up” the network by using interface tools to delete and add links. The user is able to continuously visualize the results of their manipulations and, when satisfied, save the manipulations to a persistent store. These manipulations are applied to the graph when re-created by the learning engine so that at runtime a query will retrieve exactly the response from the network that the administrative user envisages.

Allowing a complete visualization of the network space together with persisting the manipulations, through use of an edit history, and allowing modifications to query results gives an administrative user vast control over the way that a learned network behaves at runtime.

### WORKED EXAMPLE

Let us consider an example in which a machine learning engine is used to create a graph that is used at runtime by a chatbot executing on a server to answer questions received from users about insurance; that is, the chatbot uses the graph to provide a back-end interface for an FAQ system that answers customer queries about insurance. In order to create the graph, the insurer feeds the network with input data that includes possible questions that a consumer can ask. The insurer injects answers as attributes into the graph, such that retrieval of a question is matched to an answer. This provides an elementary platform for a question answering service implemented by the chatbot.

It is important for any financial services company to maintain tight control over their software at runtime. The company needs to understand how the software might behave under certain conditions, and delegate the investigation of these properties to a specialist user—an administrator—responsible for maintaining the graph. The graph manager allows this administrator not only to simulate queries to the graph, with potential answers that the graph might give, but they can also visualize which parts of the graph are matched with certain answers.

Visualization allows non-expert users to understand how question-retrieval works, and then get a rough grasp of the potential performance impacts of adding or removing either questions (which are nodes in the graph) or answers (which are attributes of those nodes). In one implementation, a user is able to select an attribute within a visual representation of a network data structure and the graphical user interface then highlights that attribute, such as displaying the selected attribute as a colour in a particular region of the graph. Questions about policy renewal, for example, can be coloured the same as answers about policy eligibility, which happens when questions about renewal and questions about eligibility are too close in the graph.

If an administrator sees this kind of commingling within the graph, the administrator can see the risk of that answer (shown as a colour) being retrieved by questions seeking a different response. In the language of machine learning, this is a visualization of retrieving a false positive. But the administrator is not powerless—they can use the tools provided by the graph manager to manipulate the graph as they see fit. This manipulation may include, for example, chopping up the graph to achieve the effect of isolating some parts—confining certain answers to more localized question “regions”.

Manipulations of the graph are stored in an edit history associated with the graph. Edits may be recorded using a graph-editing language. In one implementation, edits are stored using JavaScript Object Notation (JSON) format. For example, adding an attribute to a node has a format of

| | |
|---|---|
| { “execution_order” : 0, “graph_edit_specification_type” | : |
| “AddNodeAttributeAction”, “parameters” : { “attribute_value” : 1, “attribute_name” | : |
| “5b694903adee4c5f19c92472” } }. | |

The graphical user interface enables a user, such as the administrator in this example, to make one or more manipulations to the graph, including allowing administrators to add new nodes into the graph. This is useful because administrators inspecting the network can decide to add new questions—inspired by the information they see in front of them. The graph-editing language can also be used to build links from the new node back into the graph—so the new question can be placed right “next” to questions that the administrator feels are similar.

As these manipulations to the graphs are performed as a language, the graph can be rebuilt and the manipulations reapplied. The edits override any kind of automatic graph construction—so the graph manipulations happen exactly as the administrator specified each time the graph is automatically reconstructed. That is, whenever the graph is reconstructed, the edits in the associated edit history are folded-in to the new graph, with the edits being replayed on the reconstructed graph to produce a revised network data structure.

The graph visualization and manipulation process supports an iterative work-flow. The administrator can inspect a graph, apply some manipulations (adding new answers, deleting links and so on), rerun the automatic construction process (possibly folding in data newly acquired in the interim, recolouring the graph attributes and so on) and inspect the colours of certain nodes. Administrators can even elect to conduct further manipulation and rerun the automatic rebuild. When the administrator is happy with all their changes to the graph, the graph is shipped to a server, ready to answer consumer questions about insurance.

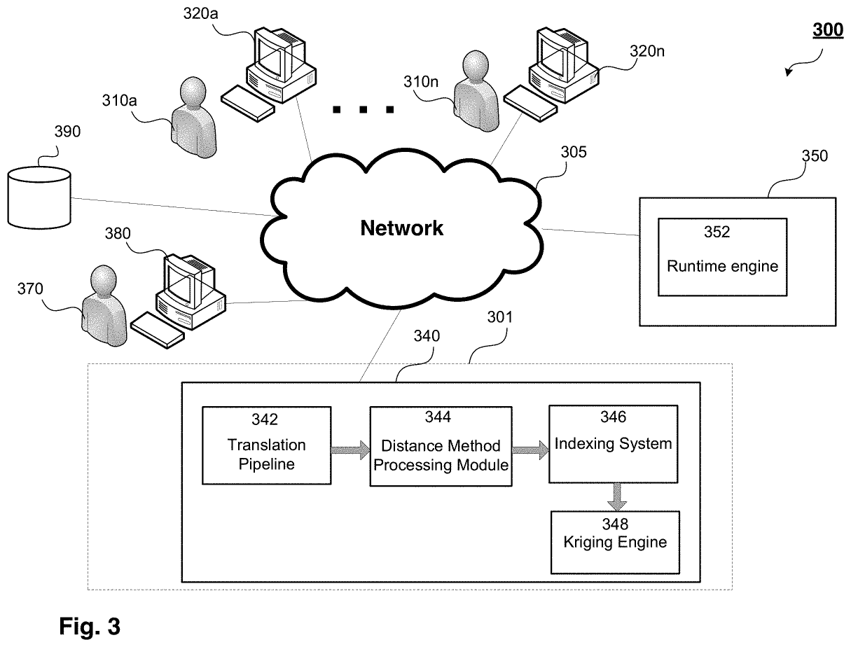

FIG. 3 is a schematic block diagram representation of a system 300 on which an embodiment of the present disclosure may be practised. The system 300 includes a graph creation server 301 for creating a graph and a query server 350 for performing runtime queries on the graph in response to natural language questions received from one or more users 310a . . . 310n accessing corresponding computing devices 320a . . . 320n.

As shown in the system 300 of FIG. 3, one embodiment uses a graph creation server 301 that includes four components:
i. a translation pipeline 342 that takes natural language text and transforms the natural language text into transformed text that a machine can compare;
ii. a distance method processing module 344 that receives the transformed text from the translation pipeline 342 and measures other transformed text;
iii. an indexing system 346 such that these distances are structured together into a network, generating a graph; and
iv. a kriging engine 348 that takes measurements and “pushes” those measurements through the network.

The query server 350 includes a runtime engine 352 for executing runtime queries on the graph created by the graph creation server 301. In the example of FIG. 3, each of the graph creation server 301 and the query server 350 is connected to a communications network 305. Each of the computing devices 320a . . . 320n is also connected to the communications network 305. The communications network 305 may be implemented using one or more wired or wireless transmission links and may include, for example, a dedicated communications link, a local area network (LAN), a wide area network (WAN), the Internet, a telecommunications network, or any combination thereof

In one embodiment, the graph creation server 301 and the query server 350 constitute a semi-supervised machine learning system for use in relation to a chatbot, a computer-implemented interface for conducting a conversation with a user to simulate a conversation with a human operator. Such a chatbot may be implemented, for example, in relation to a customer service or information acquisition application.

The graph creation server 301 receives a set of input training data comprised of natural language text. The natural language text may include seen questions, background text, seen answers, or a combination thereof. The training data may be presented as one or more files, a set of natural language questions, or a combination thereof. In one example, the input training data is received from an external database 390 coupled to the graph creation server 301 either directly, as shown, or via the communications network 305 or any other connection means.

The translation pipeline 342 transforms the received textual input data into a format intelligible to the selected distance method. For cosine distances, for example, the text is transformed into a Term-Frequency Inverse Document Frequency weighted matrix. For string kernels and string distance measurements, the text is kept as a string. The transformed text is then presented to the distance method processing module 344, which compares the transformed text strings to determine respective distances between the transformed text strings. The indexing system 346 constructs a graph from the transformed text strings and the determined distances. In one arrangement, each text string has a corresponding node in the graph. The graph creation server 301 then distributes the nodes throughout the graph. One arrangement uses a Kriging engine 348 to distribute answer ‘weights’ over the nodes. Other arrangements place an answer weight only on the nodes themselves, not propagating this weight beyond the nodes in question.

Once the graph creation server 301 has created a graph from the set of input training data, the graph can be used to perform a chat session with one of the users 310a . . . 310n. For example, user 310a accesses the computing device 320a to communicate with a website hosted in association with the query server 350. The query server 350 presents a graphical user interface to a display of the computing device 320a, wherein the graphical user interface may include a display region for presenting a textual chat session. The user 310a uses an input device, such as a keyboard or microphone, to provide a natural language query to the query server 350 via the computing device 320a and the communications network 305.

The query server 350 receives the query and projects the query into the graph created by the graph creation server 301. In one embodiment, the query server 350 has its own onboard copy of the built graph, which may be stored on a storage medium forming part of the runtime engine 352 or on an external drive, either co-located with the runtime engine 350 or accessed by the runtime engine 352 via the network 305.

Projecting the query into the graph seeks to identify a matching node in the graph. Many different transforms from text to the machine queryable ‘space’ of the created graph are possible. One implementation uses a TF-IDF weighted document score matrix. Another implementation uses neural nets to generate a synthetic space. Other spaces include the strings themselves (which are then measured using string kernels) or keyword only projections.

The query is projected into the graph to a projected location. The method then examines each node within a retrieval radius. The retrieval radius may vary depending on the application. The retrieval radius may be associated with the query or may be predefined or alternatively may be defined by a user during query runtime. When these nodes are returned, each answer on each node has a certain weight, representing the density of the correctness of that particular answer at that point (node). This number is typically valued between 0 (completely incorrect) and 1 (completely accurate).

In one arrangement, the method selects the closest n nodes to be returned by the query engine, and kriging is used to propagate answer weights from the found nodes to the query (i.e., question) node. The method then selects the highest score for each answer. This results in a list of answers (which were placed on the query nodes) and weights. The highest score is a more likely answer for the query than a low-weighted answer.

When the query server 350 identifies a matching node for the query, the query server 350 determines if there is an answer associated with the found node. If there is such an associated answer, the query server 350 returns the answer to the chatbot session for display on the computing device 320a. If there is no answer, then the query server 350 may escalate the query. In one implementation, escalating the query generates an alert for a human operator to join the chatbot session.

When the query server 350 fails to identify a matching node for the query, the query server 350 may ask the user 310a to rephrase the query, as the same query presented using different language may have a matching node. In an alternative arrangement, when the runtime serve 350 fails to identify a matching node for the query, the query server 350 escalates the query, such as by generating an alert for a human operator to join the chatbot session.

Prior to the graph becoming available for querying inputs from the one or more users 310a . . . 310n accessing corresponding computing devices 320a . . . 320n, the graph may be available for manipulation by an administrative user 370 accessing a computing device 380 coupled to the communications network 305. In one implementation, a graph manager provides a graphical user interface for display on the computing device 380. Depending on the implementation, the graph manager may form part of the graph creation server 301, the runtime server 350, the computing device 380, or a separate computing device (not shown).

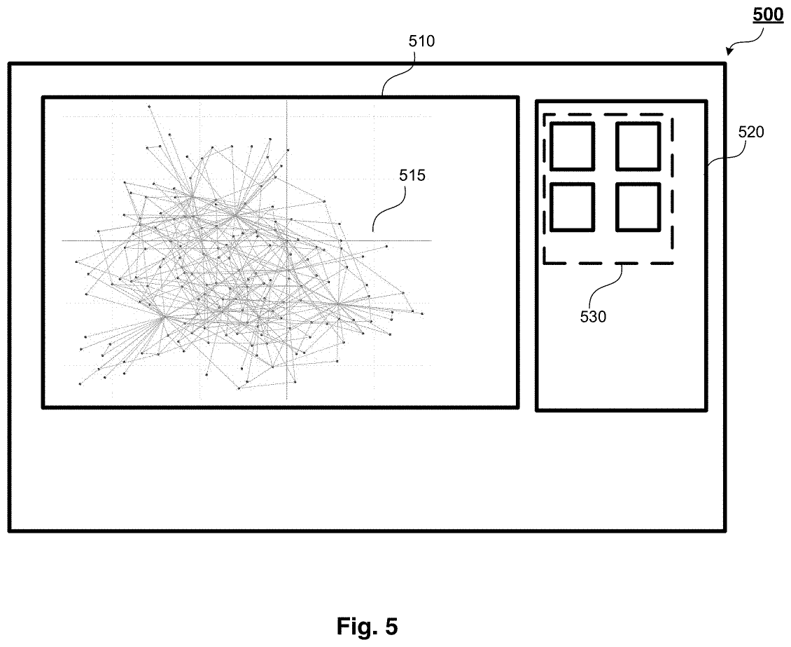

FIG. 5 is a schematic block diagram representation of a graphical user interface 500 that may be used in the system 300 for administering a network data structure. In the example of FIG. 5, the graphical user interface 500 includes a first region 510 for displaying a visual representation of a network data structure 515, such as the graph created by the graph creation server 301. The graphical user interface includes a second region 520 that includes a set of controls 530 that enable a user, such as the administrative user 370 of FIG. 3, to manipulate the network data structure 515. The set of controls may include one or more of a text box for receiving command line instructions, a set of graphical controls, or a combination thereof

Edits relating to the manipulation of the network data structure are stored as an edit history in a persistent store. In relation to the example of FIG. 3, the persistent store may be co-located with the graph creation server 301, the runtime query server 350, or as a standalone storage medium 360. Edits from the edit history are presented to the graph creation server 301 to be folded-in to any subsequent re-creation of the graph, to ensure that the user manipulations are retained.

In one embodiment, the administrative user 370 is able to access the graphical user interface displayed on the computing device 380 to edit the edit history itself, either deleting past edits that are no longer wanted or applicable, or modifying existing edits, such as changing a weighting parameter associated with a node, introducing a new answer to be associated with a node, or the like.

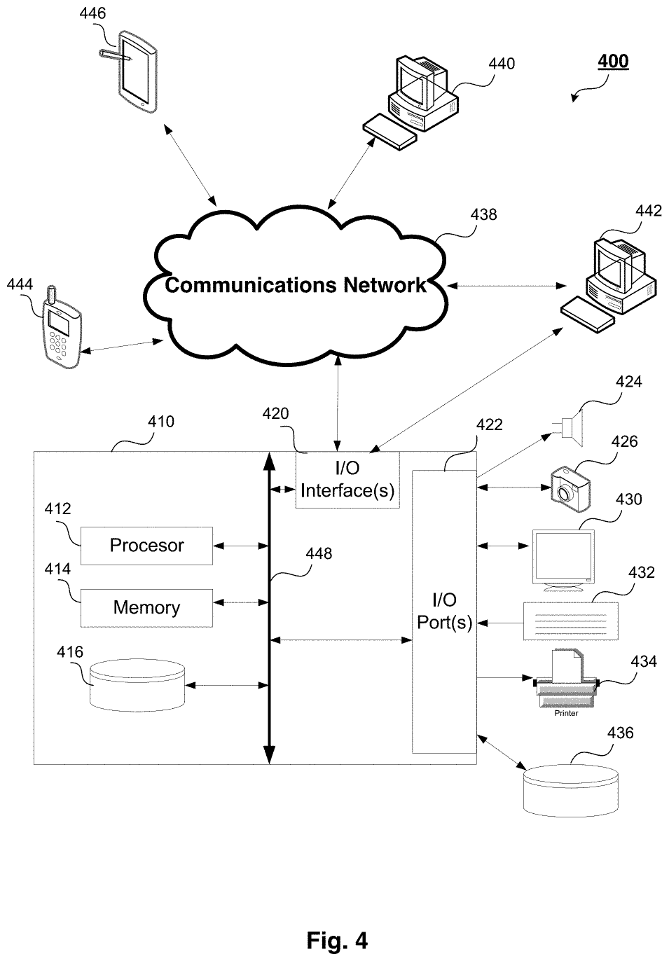

The system of the present disclosure for administering a network data structure may be practised using a computing device, such as a general-purpose computer or computer server. FIG. 4 is a schematic block diagram of a system 400 that includes a general-purpose computer 410. The general-purpose computer 410 includes a plurality of components, including: a processor 412, a memory 414, a storage medium 416, input/output (I/O) interfaces 420, and input/output (I/O) ports 422. Components of the general-purpose computer 410 generally communicate using one or more buses 448.

The memory 414 may be implemented using Random Access Memory (RAM), Read Only Memory (ROM), or a combination thereof. The storage medium 416 may be implemented as one or more of a hard disk drive, a solid state “flash” drive, an optical disk drive, or other storage means. The storage medium 416 may be utilised to store one or more computer programs, including an operating system, software applications, and data. In one mode of operation, instructions from one or more computer programs stored in the storage medium 416 are loaded into the memory 414 via the bus 448. Instructions loaded into the memory 414 are then made available via the bus 448 or other means for execution by the processor 412 to implement a mode of operation in accordance with the executed instructions.

One or more peripheral devices may be coupled to the general-purpose computer 410 via the I/O ports 422. In the example of FIG. 4, the general-purpose computer 410 is coupled to each of a speaker 424, a camera 426, a display device 430, an input device 432, a printer 434, and an external storage medium 436. The speaker 424 may be implemented using one or more speakers, such as in a stereo or surround sound system.

The camera 426 may be a webcam, or other still or video digital camera, and may download and upload information to and from the general-purpose computer 410 via the I/O ports 422, dependent upon the particular implementation. For example, images recorded by the camera 426 may be uploaded to the storage medium 416 of the general-purpose computer 410. Similarly, images stored on the storage medium 416 may be downloaded to a memory or storage medium of the camera 426. The camera 426 may include a lens system, a sensor unit, and a recording medium.

The display device 430 may be a computer monitor, such as a cathode ray tube screen, plasma screen, or liquid crystal display (LCD) screen. The display 430 may receive information from the computer 410 in a conventional manner, wherein the information is presented on the display device 430 for viewing by a user. The display device 430 may optionally be implemented using a touch screen to enable a user to provide input to the general-purpose computer 410. The touch screen may be, for example, a capacitive touch screen, a resistive touchscreen, a surface acoustic wave touchscreen, or the like.

The input device 432 may be a keyboard, a mouse, a stylus, drawing tablet, or any combination thereof, for receiving input from a user. The external storage medium 436 may include an external hard disk drive (HDD), an optical drive, a floppy disk drive, a flash drive, solid state drive (SSD), or any combination thereof and may be implemented as a single instance or multiple instances of any one or more of those devices. For example, the external storage medium 436 may be implemented as an array of hard disk drives.

The I/O interfaces 420 facilitate the exchange of information between the general-purpose computing device 410 and other computing devices. The I/O interfaces may be implemented using an internal or external modem, an Ethernet connection, or the like, to enable coupling to a transmission medium. In the example of FIG. 4, the I/O interfaces 422 are coupled to a communications network 438 and directly to a computing device 442. The computing device 442 is shown as a personal computer, but may be equally be practised using a smartphone, laptop, or a tablet device. Direct communication between the general-purpose computer 410 and the computing device 442 may be implemented using a wireless or wired transmission link.

The communications network 438 may be implemented using one or more wired or wireless transmission links and may include, for example, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a mobile telephone cellular network, a short message service (SMS) network, or any combination thereof. The general-purpose computer 410 is able to communicate via the communications network 438 to other computing devices connected to the communications network 438, such as the mobile telephone handset 444, the touchscreen smartphone 446, the personal computer 440, and the computing device 442.

One or more instances of the general-purpose computer 410 may be utilised to implement a server acting as a machine learning engine, a query runtime server, and/or a server hosting a graphical user interface to implement a method for administering a network data structure in accordance with the present disclosure. In such an embodiment, the memory 414 and storage 416 are utilised to store data relating to one or more of a created graph, a visual representation of a network data structure, one or more graphical user interface templates, an edits in an associated edit history. Software for implementing the system for administering a network data structure is stored in one or both of the memory 414 and storage 416 for execution on the processor 412. The software includes computer program code for implementing method steps in accordance with the method of administering a network data structure described herein.

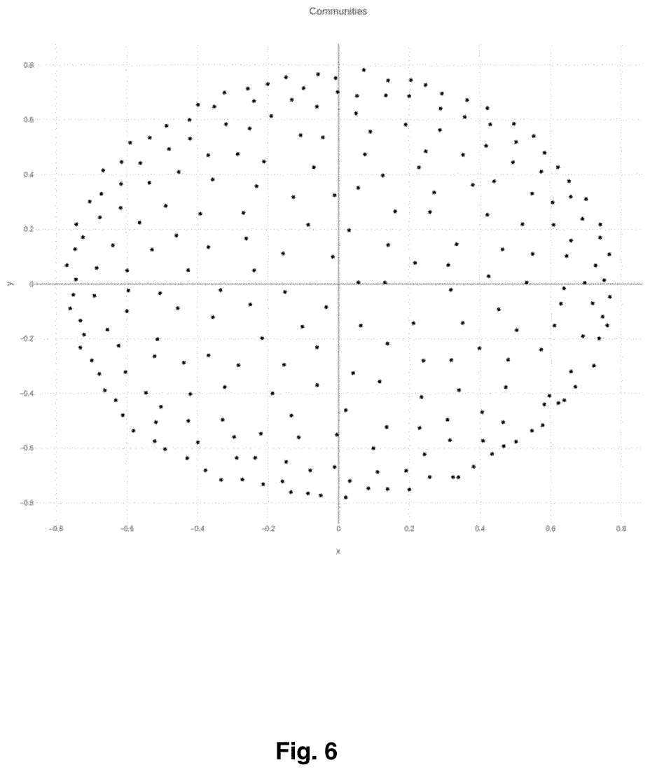

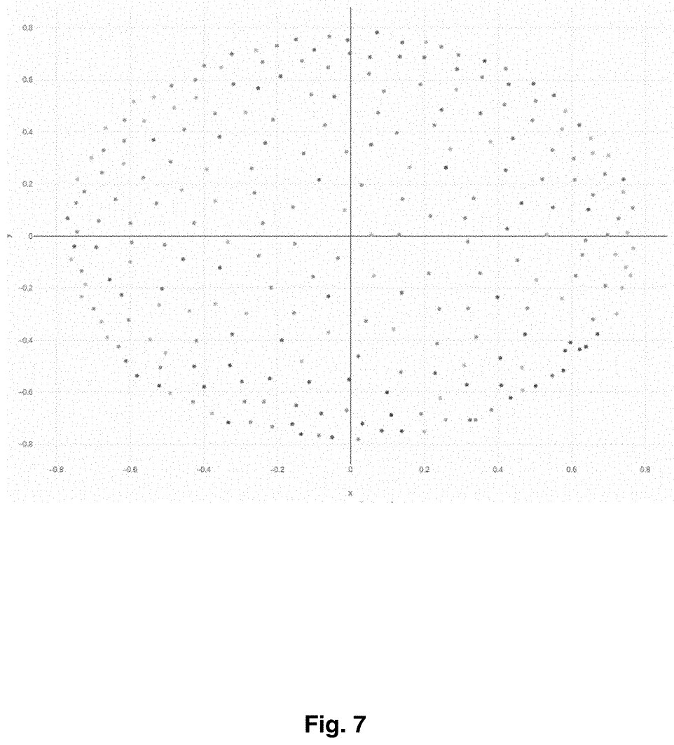

FIG. 6 is a visual representation of a macroscopic graph of a network data structure. Each point in the macroscopic graph is a “solar system” into which a user can zoom to see more detail. FIG. 7 is a visual representation of the macroscopic graph of FIG. 6, showing colouring after some kriging.

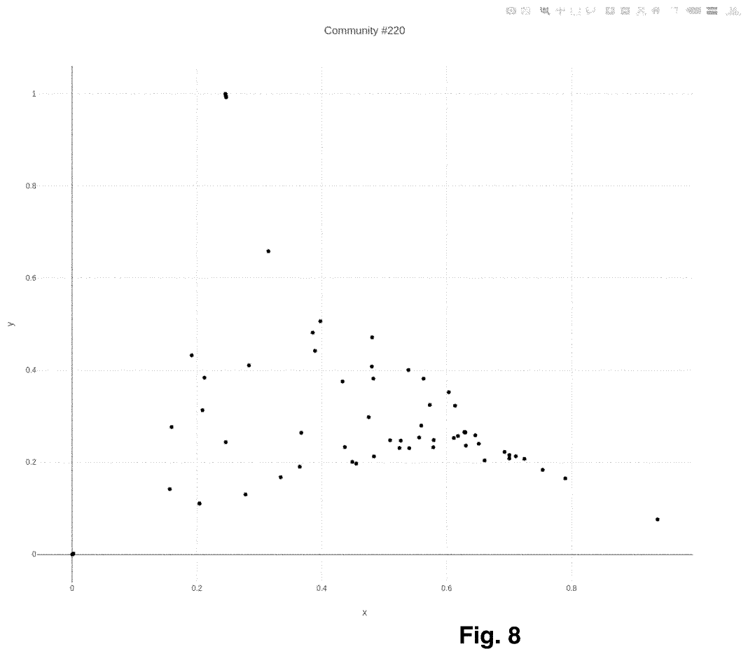

FIG. 8 is a visual representation of a microscopic solar system, arranging nodes of a network data structure in space.

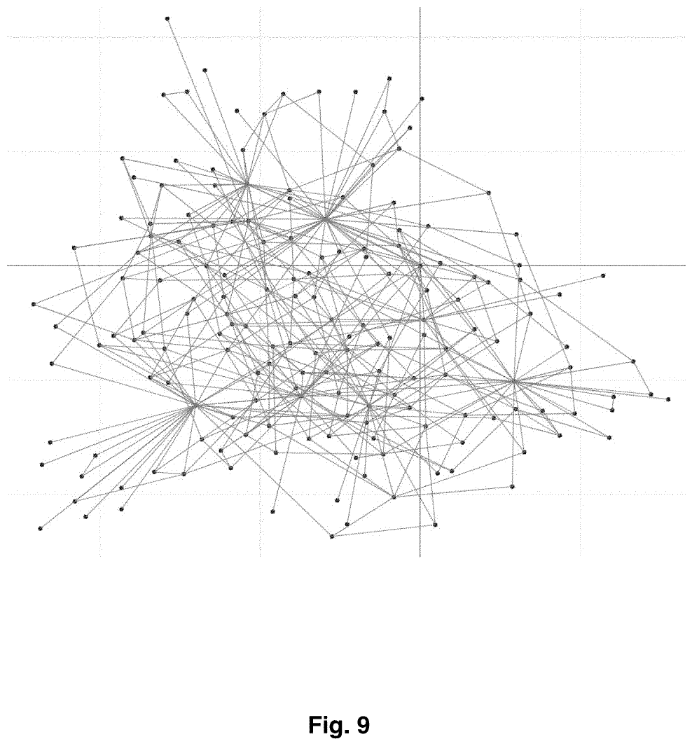

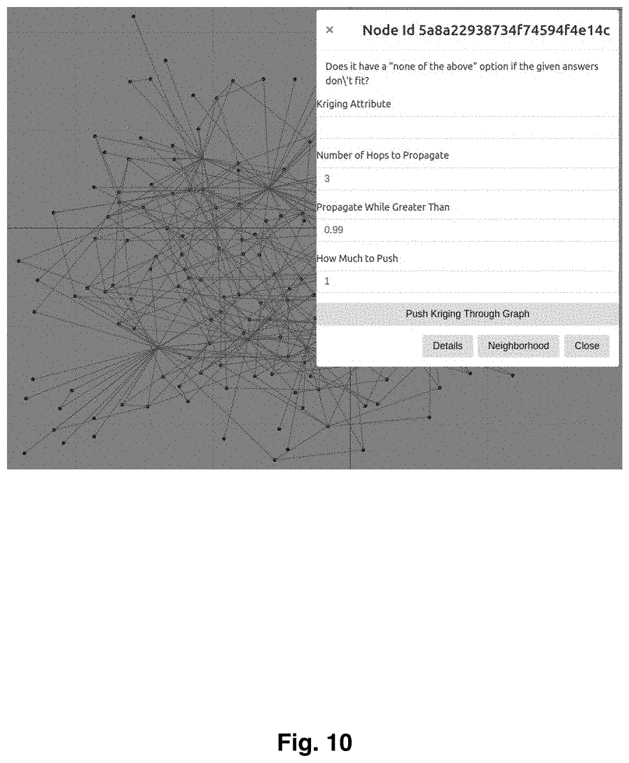

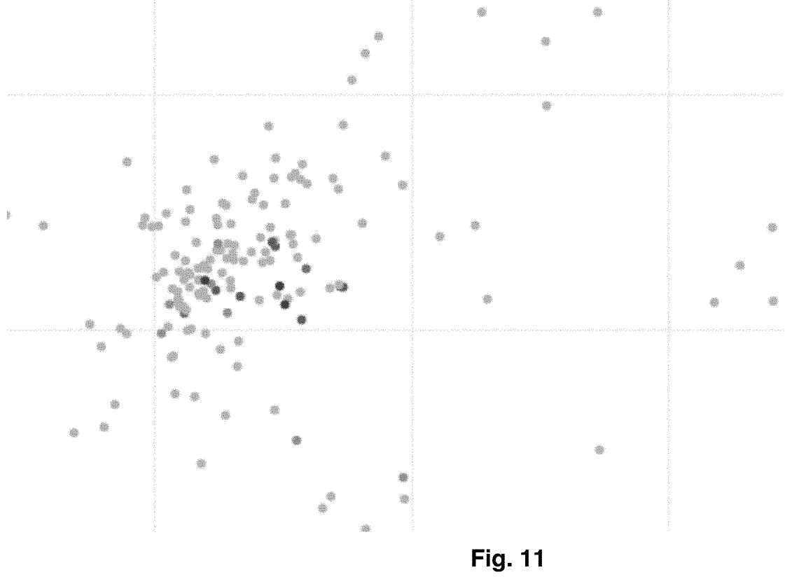

FIG. 9 is an extreme closeup view of a single node and its neighbourhood. FIG. 10 is a graphical user interface for administering a network data structure, showing a graphical user interface with controls overlaying the graph of FIG. 9. FIG. 11 is a detailed view of a graph neighbourhood with colouring appropriate for kriging.

### INDUSTRIAL APPLICABILITY

The arrangements described are applicable to the computing and customer service industries and particularly for the customer service industries utilising machine learning-based chatbots and the like.

The foregoing describes only some embodiments of the present invention, and modifications and/or changes can be made thereto without departing from the scope and spirit of the invention, the embodiments being illustrative and not restrictive.

In the context of this specification, the word “comprising” and its associated grammatical constructions mean “including principally but not necessarily solely” or “having” or “including”, and not “consisting only of”. Variations of the word “comprising”, such as “comprise” and “comprises” have correspondingly varied meanings.

As used throughout this specification, unless otherwise specified, the use of ordinal adjectives “first”, “second”, “third”, “fourth”, etc., to describe common or related objects, indicates that reference is being made to different instances of those common or related objects, and is not intended to imply that the objects so described must be provided or positioned in a given order or sequence, either temporally, spatially, in ranking, or in any other manner.

Although the invention has been described with reference to specific examples, it will be appreciated by those skilled in the art that the invention may be embodied in many other forms.

1. A method of administering a network data structure, wherein the network data structure includes a set of nodes and a set of links between the nodes and further wherein the network data structure specifies a searchable index created by a machine learning algorithm, the method comprising the steps of:
generating an initial visual representation of said network data structure based on said set of nodes and said set of links;
displaying said initial visual representation in a first region of a user interface;
receiving an input from a user via the user interface, the input corresponding to a manipulation of the network data structure;
storing the input as an edit in an associated edit history;
rebuilding said network data structure by folding-in edits in said associated edit history to produce a revised network data structure.

2. The method according to claim 1, comprising the further steps of:
generating a current visual representation of said revised network structure; and
displaying said current visual representation as a region of said user interface.

3. The method according to claim 1, wherein rebuilding said network data structure further includes folding-in new input data and applying the stored edits to that rebuilt network data structure, said new input data including at least one of a seen question, a seen answer, and background text.

4. The method according to claim 1, wherein said manipulation of said network data structure includes at least one of reweighting at least one link, adding a link, deleting a link, adding a node, deleting a node, cutting a portion of said network data structure, joining two portions of said network data structure, and redistributing nodes throughout said network.

5. The method according to claim 1, wherein generating said initial visual representation includes projecting said set of nodes and said set of links onto a 2-dimensional plane.

6. The method according to claim 1, wherein generating said initial visual representation includes projecting said set of nodes and said set of links into a 3-dimensional space.

7. The method according to claims 1 to 6, wherein said input is received via a set of graphical tools displayed in a second region of said user interface.

8. The method according to claim 7, wherein said set of graphical tools are adapted to perform at least one of the following functions in relation to said initial visual representation: zoom, scroll, reweight at least one link, add a link, delete a link, add a node, delete a node, cut a portion of said network data structure, join two portions of said network data structure, and redistribute nodes throughout said network

9. The method according to claim 1, wherein said initial visual representation applies at least one colour to one or more selected nodes from said set of nodes, based on attributes of said selected nodes.

10. The method according to claim 4, wherein said manipulation relates to redistributing attributes across said set of nodes by changing a Kriging parameter.

11. A system for administering a network data structure, wherein the network data structure includes a set of nodes and a set of links between the nodes and further wherein the network data structure specifies a searchable index created by a machine learning algorithm, the system comprising:
a graph manager that receives said network data structure and generates an initial visual representation of said network data structure based on said set of nodes and said set of links;
a software client adapted to display said initial visual representation in a first region of a user interface on a display of a client computing device, wherein said user interface is adapted to receive an input from a user via the user interface, the input corresponding to a manipulation of the network data structure;
a persistent store for storing said user input as an edit in an associated edit history;
a graph builder for rebuilding said network data structure using said machine learning algorithm, and then folding-in edits in said associated edit history to produce a revised network data structure.

12. The system according to claim 11, wherein said graph builder generates said network data structure from an initial set of input data, said initial set of input data including at least one of a seen question, a seen answer, and background text.

13. The system according to claim 12, wherein said graph builder produces said revised network data structure based on said initial set of input data.
